(19) United States
(12) Patent Application Publication
(10) Pub. No.: US 2016/0096265 A1
(43) Pub. Date: Apr. 7, 2016

(54) Creeper Tool Device

(71) Applicants: Jerry Scott, Los Angeles, CA (US); Treva Cain, Los Angeles, CA (US)

(72) Inventors: Jerry Scott, Los Angeles, CA (US); Treva Cain, Los Angeles, CA (US)

(21) Appl. No.: 14/504,630

(22) Filed: Oct. 2, 2014

(51) Int. Cl. B25H 5/00

(52) U.S. Cl. CPC B25H 5/00

(57) ABSTRACT

A creeper tool device ensures that tools and fasteners are readily accessible while working on an underbody of a vehicle. The device includes a support member having a top surface, a bottom surface, a first end, a second end and a pair of opposed sides extending between the first end and the second end. The top surface is configured for supporting a head and upper body of a user thereon when the user is lying in a supine position. A plurality of magnets is coupled to the support member wherein each of the magnets is configured for receiving a fastener thereon for magnetically coupling the fastener to the associated magnet. A plurality of casters is coupled to the bottom surface of the support member.

### BACKGROUND OF THE DISCLOSURE

### Field of the Disclosure

The disclosure relates to tool devices and more particularly pertains to a new tool device for ensuring that tools and fasteners are readily accessible while working on an underbody of a vehicle.

### SUMMARY OF THE DISCLOSURE

An embodiment of the disclosure meets the needs presented above by generally comprising a support member having a top surface, a bottom surface, a first end, a second end and a pair of opposed sides extending between the first end and the second end. The top surface is configured for supporting a head and upper body of a user thereon when the user is lying in a supine position. A plurality of magnets is coupled to the support member wherein each of the magnets is configured for receiving a fastener thereon for magnetically coupling the fastener to the associated magnet. A plurality of casters is coupled to the bottom surface of the support member.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a creeper tool device according to an embodiment of the disclosure.

FIG. 2 is an in-use top view of an embodiment of the disclosure.

FIG. 3 is a bottom view of an embodiment of the disclosure.

FIG. 4 is a cross-sectional view of an embodiment of the disclosure taken along line 4-4 of FIG. 2.

### DESCRIPTION OF THE PREFERRED EMBODIMENT

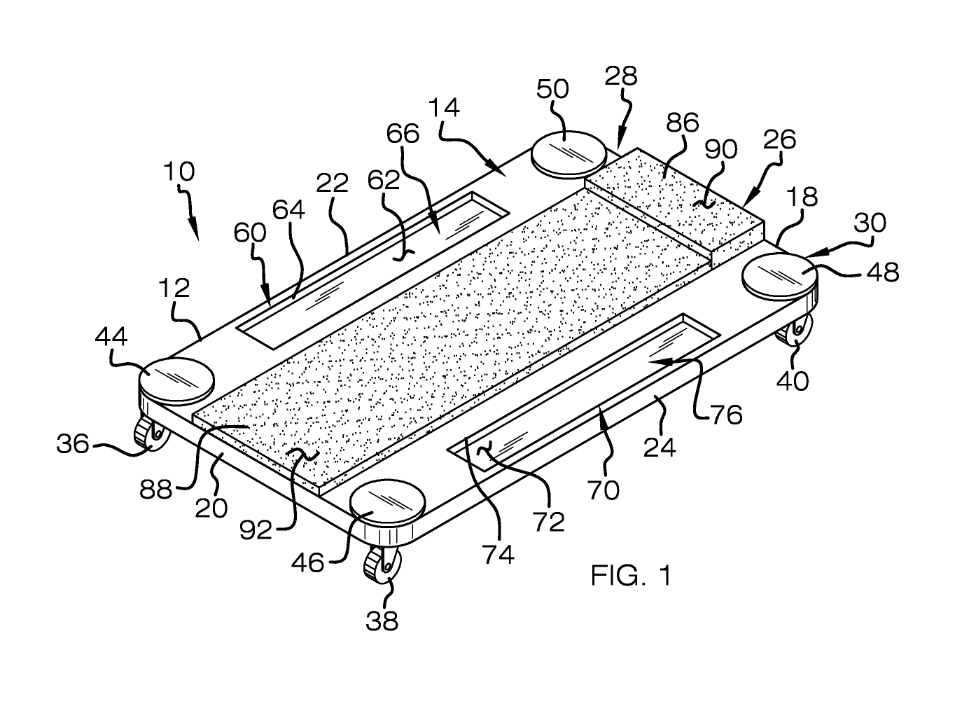

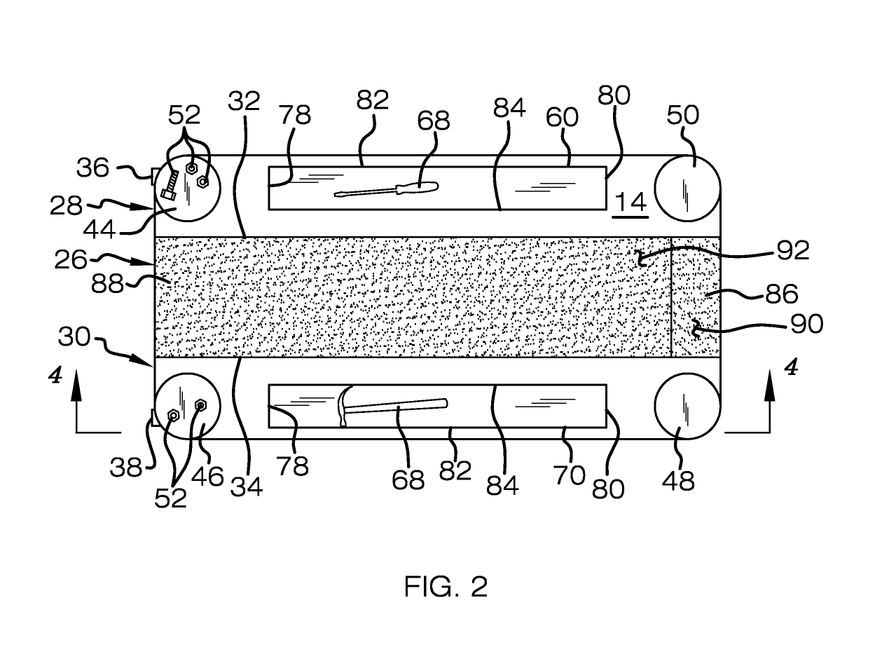

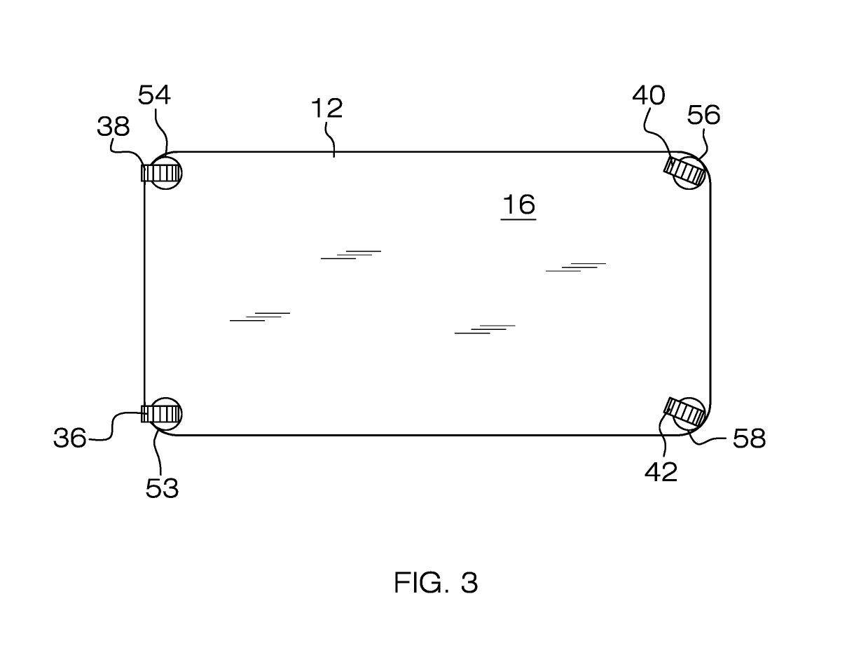

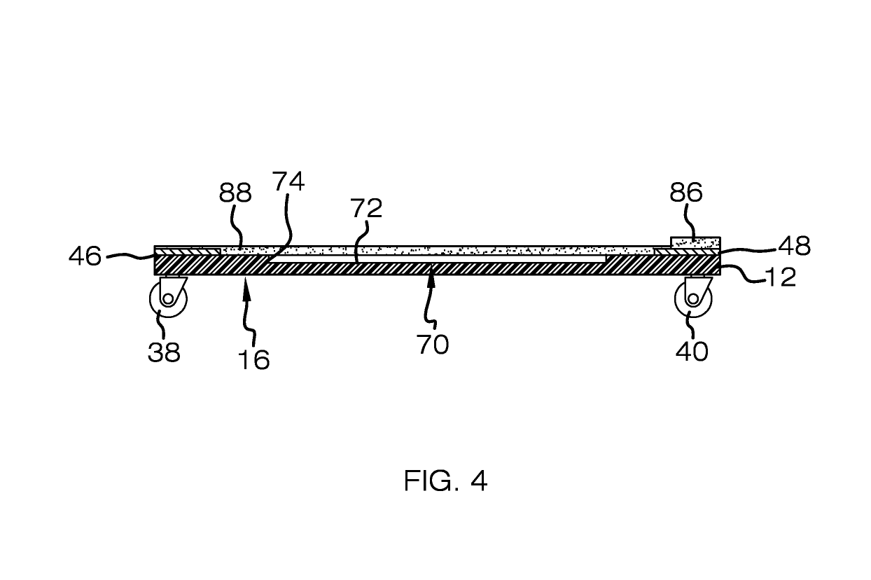

With reference now to the drawings, and in particular to FIGS. 1 through 4 thereof, a new tool device embodying the principles and concepts of an embodiment of the disclosure and generally designated by the reference numeral 10 will be described.

As best illustrated in FIGS. 1 through 4, the creeper tool device 10 generally comprises a support member 12 having a top surface 14, a bottom surface 16, a first end 18, a second end 20 and a pair of opposed sides 22, 24 extending between the first end 18 and the second end 20. The top surface 14 is configured for supporting a head and upper body of a user thereon when the user is lying in a supine position, such as when the user is working on an underbody of a vehicle. The support member 12 includes a central section 26 extending longitudinally between the first end 18 and the second end 20 and a pair of side sections 28, 30 each coupled to and extending along opposite edges 32, 34 of the central section 26. A distance between the first end 18 and the second end 20 may measure between approximately 70.0 cm and 90.0 cm. A distance between the opposed sides 22, 24 may measure between approximately 50.0 cm and 70.0 cm.

A plurality of casters 36, 38, 40, 42, wheels or the like is coupled to the bottom surface 16 of the support member 12. A plurality of magnets 44, 46, 48, 50 is coupled to the support member 12 wherein each of the magnets 44, 46, 48, 50 is configured for receiving a fastener 52 thereon for magnetically coupling the fastener 52 to the associated magnet 44, 46, 48, 50. Each of the magnets 44, 46, 48, 50 is positioned at a respective corner 53, 54, 56, 58 of the support member 12.

A first tray 60 is coupled to the top surface 14 of the support member 12, and more particularly, may be integrally coupled to the support member 12 such that the first tray 60 extends downwardly into the top surface 14 of the support member 12. The first tray 60 is coupled to a first one 28 of the side sections 28, 30 and includes a bottom wall 62 and a perimeter wall 64 attached to and extending upwardly from the bottom wall 62 defining an interior space 66 of the first tray 60 configured for receiving tools 68 therein.

A second tray 70 is coupled to the top surface 14 of the support member 12, and more particularly, may be integrally coupled to the support member 12 such that the second tray 70 extends downwardly into the top surface 14 of the support member 12. The second tray 70 is coupled to a second one 30 of the side sections 28, 30 and includes a lower wall 72 and a peripheral wall 74 attached to and extending upwardly from the lower wall 72 defining an interior space 76 of the second tray 70 configured for receiving tools 68 therein. Each of the first 60 and second 70 trays may be elongated having a pair of short sides 78, 80 coupled to and extending between a pair of long sides 82, 84. A longitudinal axis extending between the short sides 78, 80 of each of the first 60 and second 70 trays is parallel with respect to each other and to the opposed sides 22, 24 of the support member 12.

A head cushion 86 is coupled to and extends upwardly from the top surface 14 of the central section 26 of the support member 12. The head cushion 86 is positioned proximate the first end 18 of the support member 12 and extends inwardly from the first end 18 of the support member 12 toward the second end 20 of the support member 12. A back cushion 88 is coupled to and extends upwardly from the top surface 14 of the central section 26 of the support member 12. The back cushion 88 extends from the second end 20 of the support member 12 toward the first end 18 of the support member 12. The head cushion 86 and the back cushion 88 may be coupled together. A top surface 90 of the head cushion 86 may be elevated above an upper surface 92 of the back cushion 88.

In use, fasteners 52 are placed on one or more of the magnets 44, 46, 48, 50. Desired tools 68, such as a hammer, screwdriver or the like, are positioned in the first 60 and second 70 trays. A person then lays down on the central section 26 in a supine position such that the person's head rests on the head cushion 86 and the person's back rests on the back cushion 88. The device 10 is then rolled underneath a vehicle to perform maintenance or repairs on the underbody of the vehicle. In this manner, the device 10 ensures that tools 68 and fasteners 52 are readily accessible to the person while working on the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A creeper tool device comprising:
a support member having a top surface, a bottom surface, a first end, a second end and a pair of opposed sides extending between said first end and said second end, said top surface being configured for supporting a head and upper body of a user thereon when the user is lying in a supine position;
a plurality of magnets coupled to said support member wherein each of said magnets is configured for receiving a fastener thereon for magnetically coupling the fastener to said associated magnet, each of said magnets being positioned entirely on said top surface of said support member; and
a plurality of casters coupled to said bottom surface of said support member.

2. The device of claim 1, further comprising:
said support member including a central section extending longitudinally between said first end and said second end and a pair of side sections each coupled to and extending along opposite edges of said central section; and
a first tray coupled to said top surface of said support member, said first tray being coupled to a first one of said side sections, said first tray having a bottom wall and a perimeter wall attached to and extending upwardly from said bottom wall defining an interior space of said first tray configured for receiving tools therein.

3. The device of claim 2, further comprising said first tray being integrally coupled to support member wherein said first tray extends downwardly into said top surface of said support member.

4. The device of claim 2, further comprising a second tray coupled to said top surface of said support member, said second tray being coupled to a second one of said side sections, said second tray having a lower wall and a peripheral wall attached to and extending upwardly from said lower wall defining an interior space of said second tray configured for receiving tools therein.

5. The device of claim 4, further comprising said second tray being integrally coupled to said support member wherein said second tray extends downwardly into said top surface of said support member.

6. The device of claim 1, further comprising:
said support member including a central section extending longitudinally between said first end and said second end and a pair of side sections each coupled to and extending along opposite edges of said central section; and
a head cushion coupled to and extending upwardly from said top surface of said central section of said support member, said head cushion being positioned proximate said first end of said support member.

7. The device of claim 1, further comprising:
said support member including a central section extending longitudinally between said first end and said second end and a pair of side sections each coupled to and extending along opposite edges of said central section; and
a back cushion coupled to and extending upwardly from said top surface of said central section of said support member, said back cushion extending from said second end of said support member toward said first end of said support member.

8. The device of claim 6, further comprising a back cushion coupled to and extending upwardly from said top surface of said central section of said support member, said back cushion extending from said second end of said support member toward said first end of said support member, said back cushion being coupled to said head cushion, a top surface of said head cushion being elevated above an upper surface of said back cushion.

9. The device of claim 6, further comprising said head cushion extending inwardly from said first end of said support member toward said second end of said support member.

10. The device of claim 1, further comprising each of said magnets being positioned at a respective corner of said support member.

11. The device of claim 4, further comprising each of said first and second trays being elongated having a pair of short sides coupled to and extending between a pair of long sides, a longitudinal axis extending between said short sides of each of said first and second trays being parallel with respect to each other and to said opposed sides of said support member.

12. A creeper tool device comprising:
a support member having a top surface, a bottom surface, a first end, a second end and a pair of opposed sides extending between said first end and said second end, said top surface being configured for supporting a head and upper body of a user thereon when the user is lying in a supine position, said support member including a central section extending longitudinally between said first end and said second end and a pair of side sections each coupled to and extending along opposite edges of said central section;
a plurality of casters coupled to said bottom surface of said support member;
a first tray coupled to said top surface of said support member, said first tray being coupled to a first one of said side sections, said first tray having a bottom wall and a perimeter wall attached to and extending upwardly from said bottom wall defining an interior space of said first tray configured for receiving tools therein, said first tray being integrally coupled to support member wherein said first tray extends downwardly into said top surface of said support member;
a second tray coupled to said top surface of said support member, said second tray being coupled to a second one of said side sections, said second tray having a lower wall and a peripheral wall attached to and extending upwardly from said lower wall defining an interior space of said second tray configured for receiving tools therein, said second tray being integrally coupled to said support member wherein said second tray extends downwardly into said top surface of said support member;
each of said first and second trays being elongated having a pair of short sides coupled to and extending between a pair of long sides, a longitudinal axis extending between said short sides of each of said first and second trays being parallel with respect to each other and to said opposed sides of said support member;
a plurality of magnets coupled to said support member wherein each of said magnets is configured for receiving a fastener thereon for magnetically coupling the fastener to said associated magnet, each of said magnets being positioned at a respective corner of said support member, each of said magnets being positioned entirely on said top surface of said support member;
a head cushion coupled to and extending upwardly from said top surface of said central section of said support member, said head cushion being positioned proximate said first end of said support member, said head cushion extending inwardly from said first end of said support member toward said second end of said support member; and
a back cushion coupled to and extending upwardly from said top surface of said central section of said support member, said back cushion extending from said second end of said support member toward said first end of said support member, said back cushion being coupled to said head cushion, a top surface of said head cushion being elevated above an upper surface of said back cushion.
